(19) United States
(12) Patent Application Publication
(10) Pub. No.: US 2020/0087971 A1
(43) Pub. Date: Mar. 19, 2020

(54) DOOR DRIVING DEVICE

(71) Applicant: NABTESCO CORPORATION, Tokyo (JP)

(72) Inventor: Shinji UEDA, Kobe-shi (JP)

(21) Appl. No.: 16/550,571

(22) Filed: Aug. 26, 2019

(30) Foreign Application Priority Data
Sep. 18, 2018 (JP) 2018-173502

(51) Int. Cl. E05F 15/635; E05F 15/655

(52) U.S. Cl. CPC E05F 15/635; E05F 15/655; E05Y 2201/604; E05Y 2900/51; E05Y 2201/434

(57) ABSTRACT

A door driving device includes: a base member extending in an opening width direction of a door; a rotary moving unit pressed against the base member and configured to move along the base member while rotating; a rotary shaft extending in the opening width direction of the door and configured to rotate by a power of a motor; and a transmission member. The transmission member can move relatively to the rotary shaft in the axial direction thereof. The transmission member also rotates along with the rotary shaft and contacts with the rotary moving unit, thereby to transmit the rotational power of the rotary shaft to the rotary moving unit.

### CROSS-REFERENCE TO RELATED APPLICATIONS

This application is based on and claims the benefit of priority from Japanese Patent Application Serial No. 2018-173502 (filed on Sep. 18, 2018), the contents of which are hereby incorporated by reference in their entirety.

### TECHNICAL FIELD

The present invention relates to a door driving device for moving a door leaf.

### BACKGROUND

A door driving device is disclosed in Japanese Laid-Open Patent Publication No. 4-228788 (“the '788 Publication”). The door driving device disclosed in the '788 Publication includes a reversible screw and a carriage that reciprocates along the reversible screw. The carriage includes a nut that slides on the reversible screw. When the reversible screw rotates, the carriage moves along the reversible screw. Movement of the carriage causes a door leaf to move.

The above door driving device includes a reversible screw. By contrast, there is another known door driving device having a rack-and-pinion structure and configured to move a door leaf. In this door driving device, the pinion rotates and moves by the power of a motor. The pinion and the motor move integrally with each other. The movement of the pinion causes the door leaf to move. In a door driving device having such a structure, it is difficult to downsize a moving unit (a structure including the pinion and the motor) that moves a door leaf. The present invention provides a door driving device having a small size.

### SUMMARY

(1) A door driving device that solves the above problem comprises: a base member extending in an opening width direction of a door; a rotary moving unit pressed against the base member and configured to move along the base member while rotating; a rotary shaft extending in the opening width direction of the door and configured to rotate by a power of a motor; and a transmission member capable of moving relatively to the rotary shaft in an axial direction thereof and configured to rotate along with the rotary shaft and contact with the rotary moving unit, so as to transmit a rotational power of the rotary shaft to the rotary moving unit. In this arrangement, it is not necessary to build the motor into the rotary moving unit for integrated operation, and therefore, the moving unit including the rotary moving unit can have a small size.

(2) A door driving device that solves the above problem comprises: a base member extending in an opening width direction of a door; two rotary moving units pressed against the base member and configured to move along the base member while rotating; a rotary shaft extending in the opening width direction of the door and configured to rotate by a power of a motor; and two transmission members provided in association with the two rotary moving units, respectively, the two transmission members being capable of moving relatively to the rotary shaft in an axial direction thereof and configured to rotate along with the rotary shaft and contact with the two rotary moving units, so as to transmit a rotational power of the rotary shaft to the two rotary moving units, wherein the two transmission members transmit the rotational power to the two rotary moving units such that the two rotary moving units rotate in opposite directions. In this arrangement, one rotary shaft can cause the two rotary moving units to move in opposite directions, and this can simplify the structure of a biparting door.

(3) In the above door driving device, the motor is positioned in a middle portion in the opening width direction of the door. In this arrangement, the door driving device can have a small dimension in the opening width direction.

(4) In the above door driving device, further provided is a retainer for retaining the rotary moving unit rotatably and retaining a door leaf. For the structure in which the door leaf is mounted directly to the rotary moving unit, the movement of the door leaf may be instable. By contrast, in the above arrangement, the door leaf is fastened to the retainer, and the movement of the door leaf is stable.

(5) In the above door driving device, the retainer includes a body portion, a first supported portion, and a second supported portion, the body portion retaining the rotary moving unit, the first supported portion being provided on the body portion and supported by the base member, the second supported portion being provided on the body portion and supported by the rotary shaft. In this arrangement, the retainer is supported by the base member and the rotary shaft, and therefore, the movement along the base member and the rotary shaft is stable.

(6) In the above door driving device, the transmission member includes a first gear configured to rotate about a rotational center axis of the rotary shaft, and the rotary moving unit includes a second gear configured to mesh with the first gear. In this arrangement, the rotational power is transmitted by the gears, and thus slip is suppressed in transmitting the rotational power as compared to the case where the rotational power is transmitted only by contact.

### BRIEF DESCRIPTION OF THE DRAWINGS

FIG. 1 is a front view of a vehicle.

FIG. 2 is a perspective view of a door driving device.

FIG. 3 is a partial perspective view of the door driving device.

FIG. 4 is a perspective view of a speed reducer.

FIG. 5 is a perspective view of a moving unit.

FIG. 6 is an exploded perspective view of the moving unit.

FIG. 7 is a sectional view of a rotary shaft and a sliding member.

FIG. 8 is a side view of the moving unit.

FIG. 9 is a sectional view along a line IX-IX of FIG. 8.

FIG. 10 explains an operation of the moving unit.

### DESCRIPTION OF THE EMBODIMENTS

The door driving device will now be described with reference to FIGS. 1 to 10.

A railroad vehicle 1 includes a door. The door includes door leaves 3 for opening and closing a door opening 2. A door driving device 10 moves the door leaf 3. The door leaf 3 moves along the front-rear direction of the vehicle. The door driving device 10 is mounted to the railroad vehicle 1 to neighbor the door opening 2.

For example, the door driving device 10 is installed in a wall above the door opening 2. The door leaf 3 is hung from a guide rail with a hanger (not shown) and is guided in the front-rear direction by the guide rail extending in the front-rear direction of the vehicle 1. The door leaf 3 moves on the power of the door driving device 10.

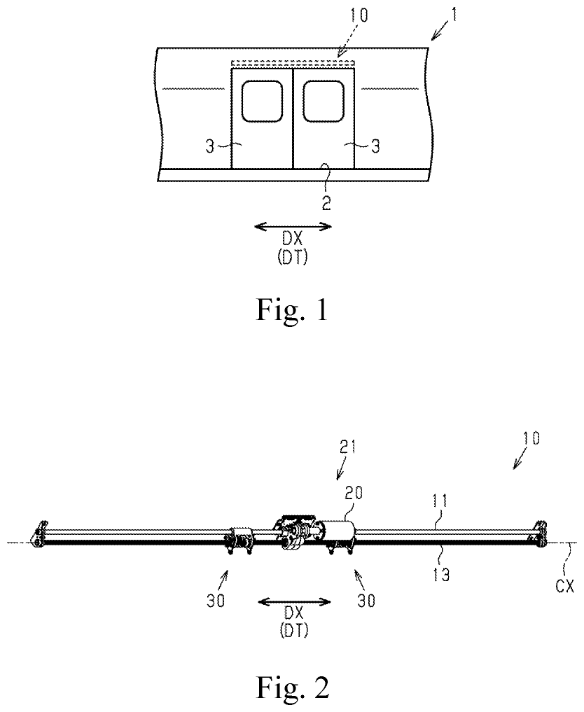

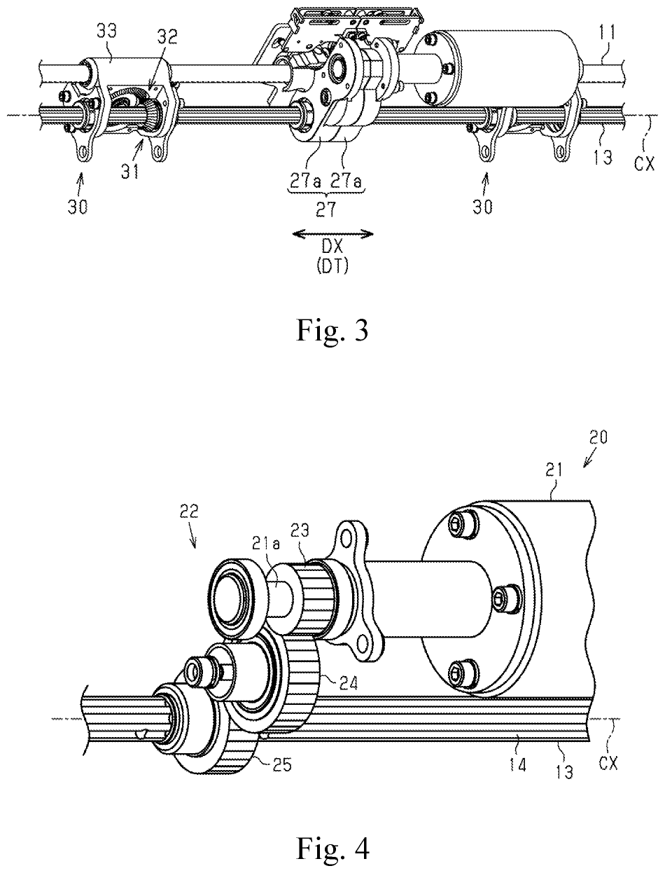

As shown in FIGS. 2 and 3, the door driving device 10 includes a base member 11, a rotary shaft 13 that rotates by the power of a motor 21, a rotary moving unit 32, and a transmission member 31. The rotary moving unit 32 is preferably a component of a moving unit 30 that moves the door leaf 3.

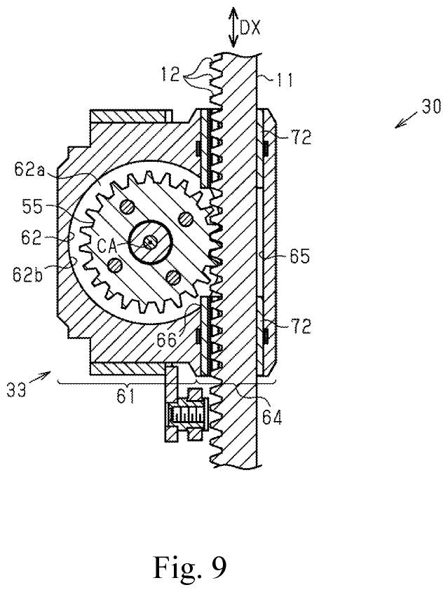

The base member 11 extends in the opening width direction DT of the door. In other words, the base member 11 is installed such that the extension direction DX thereof corresponds to the opening width direction DT of the door. The base member 11 includes teeth 12 (see FIG. 9) arranged in the extension direction DX thereof. The teeth 12 of the base member 11 mesh with the rotary moving unit 32 described above. More specifically, the base member 11 is formed as a rack in a rack-and-pinion structure.

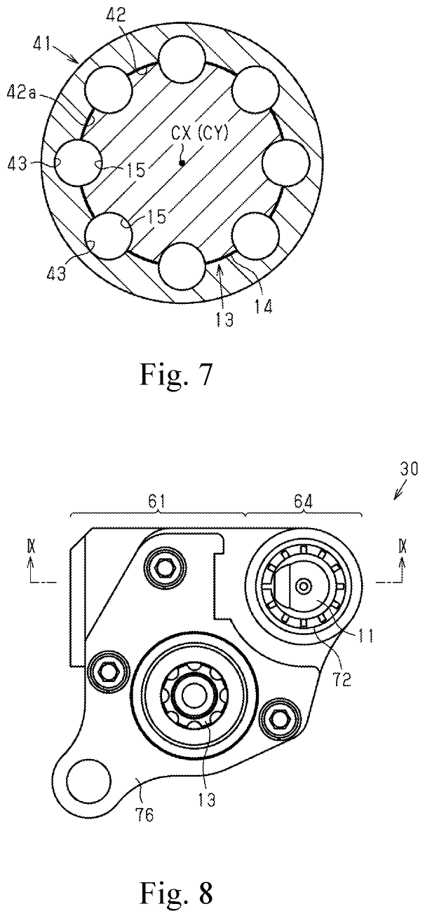

The rotary shaft 13 extends along the extension direction DX of the base member 11. The rotary shaft 13 is arranged in parallel to the base member 11 and rotates about the rotational center axis CX of the rotary shaft 13. The rotational center axis CX extends along the extension direction DX of the base member 11. The rotary shaft 13 rotates by the power of a drive device 20 (described later). The rotary shaft 13 has a circumferential surface 14 along the circumference centered at the rotational center axis CX. The circumferential surface 14 (see FIG. 7) has at least one groove 15 formed therein and extending in parallel to the rotational center axis CX.

As shown in FIG. 4, the drive device 20 includes the motor 21 and the speed reducer 22. The speed reducer 22 includes an output gear 23, a first reduction gear 24, and a second reduction gear 25. The output gear 23 is mounted to an output shaft 21a of the motor 21, the first reduction gear 24 meshes with the output gear 23, and the second reduction gear 25 meshes with the first reduction gear 24. The output gear 23, the first reduction gear 24, and the second reduction gear 25 are rotatably housed in a casing 27 constituted by a pair of cases 27a. The output gear 23 rotates integrally with the output shaft 21a of the motor 21. The first reduction gear 24 rotates on rotation of the output gear 23. The second reduction gear 25 rotates on rotation of the first reduction gear 24. The second reduction gear 25 rotates integrally with the rotary shaft 13. The rotational power of the motor 21 is transmitted to the rotary shaft 13 via the output gear 23, the first reduction gear 24, and the second reduction gear 25. Thus, the rotary shaft 13 rotates by the power of the motor 21.

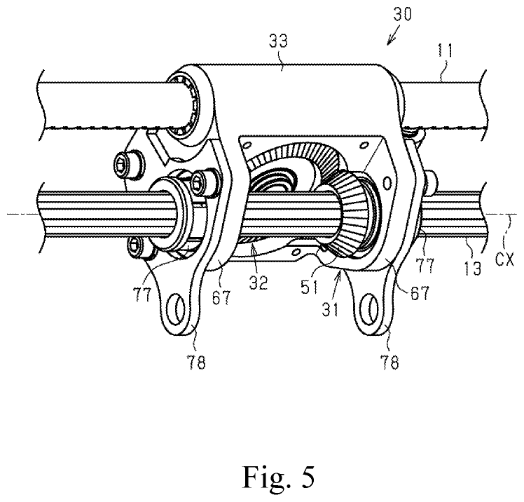

The moving unit 30 and the transmission member 31 will now be described with reference to FIGS. 5 to 9.

The moving unit 30 moves on the rotational power of the rotary shaft 13. The rotational power of the rotary shaft 13 is transmitted to the moving unit 30 via the transmission member 31.

The transmission member 31 can move relatively to the rotary shaft 13 in the axial direction thereof. The transmission member 31 also rotates along with the rotary shaft 13 and contacts with the rotary moving unit 32 of the moving unit 30, thereby to transmit the rotational power of the rotary shaft 13 to the rotary moving unit 32 of the moving unit 30. Further, when transmitting the rotational power of the rotary shaft 13 to the rotary moving unit 32 of the moving unit 30, the transmission member 31 receives a force from the moving unit 30 and moves along with the moving unit 30.

More specifically, the transmission member 31 includes a sliding member 41 and a first bevel gear 51 (a first gear). The sliding member 41 rotates integrally with the rotary shaft 13 and slides in the axial direction with respect to the rotary shaft 13, and the first bevel gear 51 is coupled with the sliding member 41. The first bevel gear 51 meshes with a second bevel gear 56 (a second gear) fixed to the rotary moving unit 32 of the moving unit 30. Thus, the transmission member 31 transmits the rotational power to the rotary moving unit 32 of the moving unit 30 via the first bevel gear 51.

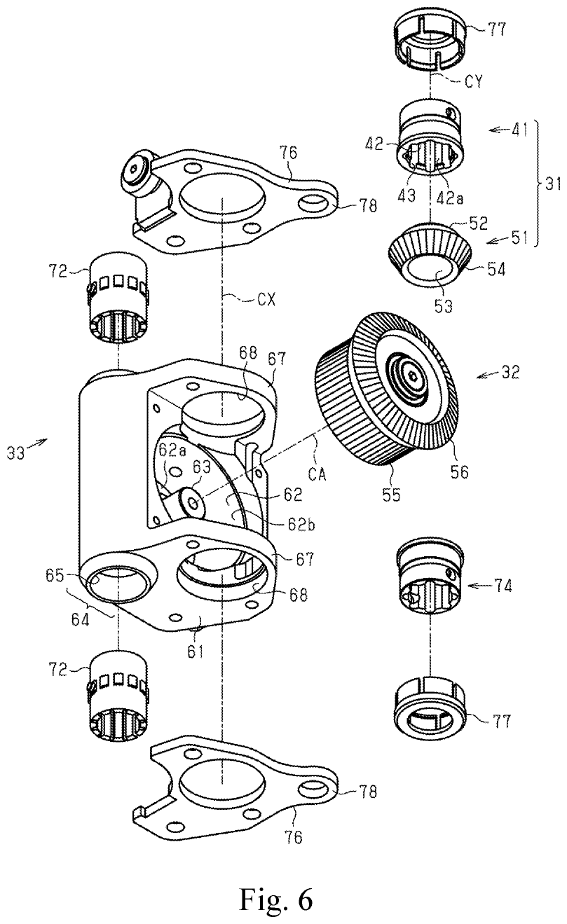

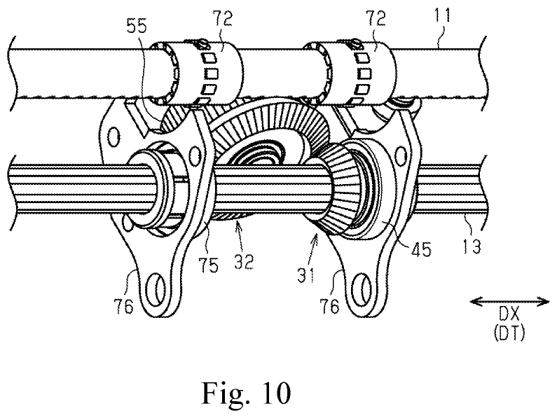

As shown in FIGS. 6 and 7, the sliding member 41 has an insertion hole 42 penetrated by the rotary shaft 13. After the sliding member 41 is mounted, the center axis CY of the insertion hole 42 corresponds to the rotational center axis CX of the rotary shaft 13 (see FIG. 7). The inner circumferential surface 42a of the insertion hole 42 extends along a circumference centered at the center axis CY. In the inner circumferential surface 42a, there is provided at least one groove 43 extending along the center axis CY. The width of the groove 43 is equal to the width of the groove 15 in the rotary shaft 13. The groove 43 in the sliding member 41 and the groove 15 in the rotary shaft 13 constitute a cylindrical space. This space houses a cylindrical rod or a spherical ball. With this structure, the sliding member 41 is restricted from rotating in the circumferential direction about the center axis CY with respect to the rotary shaft 13 and is allowed to move along the rotary shaft 13. Also, the sliding member 41 is retained by a retainer 33 via a ring-shaped bearing 45 (see FIG. 10). Thus, the sliding member 41 rotates about the center axis CY with respect to the retainer 33.

The first bevel gear 51 includes a coupling portion 52, an insertion hole 53, and bevel teeth 54. The coupling portion 52 couples with the sliding member 41, the insertion hole 53 is penetrated by the rotary shaft 13, and the bevel teeth 54 are provided around the insertion hole 53. The first bevel gear 51 couples with the sliding member 41 and rotates and moves integrally with the sliding member 41. Thus, the first bevel gear 51 rotates about the rotational center axis CX integrally with the sliding member 41 and the rotary shaft 13. The first bevel gear 51 also moves along the rotary shaft 13 with the sliding member 41.

As shown in FIG. 6, the moving unit 30 includes the rotary moving unit 32 that meshes with the base member 11. Further, the moving unit 30 includes the retainer 33 that retains the rotary moving unit 32. The rotary moving unit 32 of the moving unit 30 rotates by the rotational power received from the transmission member 31. The rotary moving unit 32 of the moving unit 30 meshes with the base member 11. Thus, when the rotary moving unit 32 rotates, the moving unit 30 moves along the base member 11.

More specifically, the rotary moving unit 32 meshes with the transmission member 31 and the base member 11. For example, the rotary moving unit 32 includes a pinion gear 55 and a second bevel gear 56. The pinion gear 55 meshes with the base member 11, and the second bevel gear 56 meshes with the first bevel gear 51 of the transmission member 31. The rotational center axis CA of the pinion gear 55 intersects the rotational center axis CX of the rotary shaft 13 perpendicularly. The rotational center axis of the second bevel gear 56 is aligned with the rotational center axis CA of the pinion gear 55. Thus, the second bevel gear 56 rotates about a line that intersects the rotational center axis CX of the rotary shaft 13 perpendicularly. The second bevel gear 56 is fixed to the pinion gear 55. Thus, the pinion gear 55 and the second bevel gear 56 rotate integrally with each other.

The retainer 33 includes a body portion 61, a first supported portion 64, and at least one second supported portion 67. The body portion 61 retains the rotary moving unit 32, the first supported portion 64 is supported by the base member 11, and the second supported portion 67 is supported by the rotary shaft 13. In the embodiment, the retainer 33 includes two second supported portions 67.

The body portion 61 of the retainer 33 includes a concave portion 62 and a spindle 63. The concave portion 62 receives the pinion gear 55, and the spindle 63 projects from the bottom surface 62a of the concave portion 62. The spindle 63 is provided in the central portion of the concave portion 62. The center axis of the spindle 63 is aligned with the rotational center axis CA of the pinion gear 55. A fastening portion 78 (described later) provided on the retainer 33 is coupled with the door leaf 3. Thus, the door leaf 3 is opened or closed when the moving unit 30 moves.

As shown in FIGS. 8 and 9, the first supported portion 64 is provided laterally to the concave portion 62 in the body portion 61. The first supported portion 64 is integrated with the body portion 61. The first supported portion 64 has an insertion hole 65 penetrated by the base member 11. The insertion hole 65 extends to intersect an inner peripheral surface 62b of the concave portion 62. The insertion hole 65 is connected to the concave portion 62 at a location where the insertion hole 65 intersects the concave portion 62. The location where the insertion hole 65 is connected to the concave portion 62 is herein referred to as “an intersection opening 66.” In the intersection opening 66, the pinion gear 55 and the base member 11 mesh with each other. The base member 11 penetrates the first supported portion 64 via a pair of sliding members 72 having a tubular shape. The sliding members 72 are fixed on the insertion hole 65 of the first supported portion 64.

The pair of second supported portions 67 project from the body portion 61 along the rotational center axis CA of the pinion gear 55. The pair of second supported portions 67 are located such that the concave portion 62 is interposed therebetween in the direction along the rotational center axis CX of the rotary shaft 13, and the pair of second supported portions 67 are also spaced from each other in the extension direction DX of the base member 11 (see FIG. 5). Each of the pair of second supported portions 67 has an insertion hole 68 penetrated by the rotary shaft 13. One of the second supported portions 67 is supported by the rotary shaft 13 via the sliding member 41 of the transmission member 31. The other of the second supported portions 67 is supported by the rotary shaft 13 via another sliding member 74. The other sliding member 74 has the same structure as the sliding member 41 of the transmission member 31 (see FIG. 6). The sliding members 41, 74 penetrate the insertion holes 68, 68 of the second supported portions 67 via bearings 45, 75 (see FIG. 10). The sliding members 41, 74 and the bearings 45, 75 are mounted to the second supported portions 67 via brackets 76, 76 and stoppers 77, 77. The brackets 76, 76 each have a fastening portion 78 fastened to the door leaf 3.

An operation of the door driving device 10 will now be described with reference to FIG. 10.

When the rotary shaft 13 rotates, the transmission member 31 rotates with rotation of the rotary shaft 13. The rotation of the transmission member 31 causes the rotary moving unit 32 to rotate. The rotation of the rotary moving unit 32 causes the moving unit 30 to move in the opening width direction DT of the door by meshing between the pinion gear 55 of the rotary moving unit 32 and the base member 11. The movement of the moving unit 30 causes the transmission member 31 to move along the rotary shaft 13 with the moving unit 30. Therefore, the rotational power is continuously transmitted from the rotary shaft 13 to the rotary moving unit 32 via the transmission member 31. Thus, in the door driving device 10, the moving unit 30 can be moved by the different structure than in a slide mechanism in which a nut is driven on rotation of a screw. In summary, the moving unit 30 is driven by converting the rotational power into a rotational power of the pinion gear 55 meshing with the base member 11. The rotational power of the rotary shaft 13, which is used to drive the moving unit 30, is transmitted to the rotary moving unit 32 via the transmission member 31. Thus, the moving unit 30 does not include a drive source such as a motor 21, and therefore, the moving unit 30 can have a smaller size than the referential moving unit that includes a drive source.

Advantageous effects of the door driving device 10 will be described below.

(1) The door driving device 10 includes the base member 11, the rotary moving unit 32, the rotary shaft 13 of the motor 21 that extends in the opening width direction DT of the door, and the transmission member 31. The rotary moving unit 32 is pressed against the base member 11 and moves along the base member 11 while rotating. The transmission member 31 can move relatively to the rotary shaft 13 in the direction of the rotational center axis CX (the axial direction) thereof. The transmission member 31 also rotates along with the rotary shaft 13 and contacts with the rotary moving unit 32, thereby to transmit the rotational power of the rotary shaft 13 to the rotary moving unit 32. In this arrangement, it is not necessary to mount the motor 21 to the rotary moving unit 32 for integrated operation, and therefore, the component that moves along the base member 11 (that is, the moving unit 30 including the rotary moving unit 32) can have a small size. For the door driving device 10 including a slide mechanism in which a nut is moved by rotation of a ball screw, it is necessary that a meshing relationship between the ball screw and the nut be specified precisely. By contrast, in the above arrangement, there is no need of using components specified precisely. Therefore, the components constituting the door driving device 10 can be worked easily.

(2) The door driving device 10 includes two rotary moving units 32 and two transmission members 31 provided for the two rotary moving units 32, respectively. The two transmission members 31 transmit the rotational power to the two rotary moving units 32 such that these rotary moving units 32 rotate in opposite directions. In this arrangement, one rotary shaft 13 causes the two rotary moving units 32 to move in opposite directions. This can simplify the structure of a biparting door.

(3) In the above door driving device 10, the motor 21 is positioned in a middle portion in the opening width direction DT of the door. In this arrangement, the door driving device 10 can have a small dimension in the opening width direction DT.

(4) Further, the door driving device 10 includes the retainer 33 that retains the rotary moving unit 32. For the structure in which the door leaf 3 is mounted directly to the rotary moving unit 32, the movement of the door leaf may be instable. By contrast, in the above arrangement, the door leaf 3 is fastened to the retainer 33, and the movement of the door leaf 3 is stable.

(5) The retainer 33 includes the body portion 61, the first supported portion 64, and the second supported portion 67. The body portion 61 retains the rotary moving unit 32, the first supported portion 64 is provided on the body portion 61 and supported by the base member 11, and the second supported portion 67 is provided on the body portion 61 and supported by the rotary shaft 13. In this arrangement, the retainer 33 is supported by the base member 11 and the rotary shaft 13, and therefore, the movement along the base member 11 and the rotary shaft 13 is stable.

(6) The transmission member 31 includes the first bevel gear 51 (the first gear) that rotates about the rotational center axis CX of the rotary shaft 13. The rotary moving unit 32 includes the second bevel gear 56 (the second gear) that meshes with the first bevel gear 51 (the first gear). In this arrangement, the rotational power is transmitted by the gears, and thus slip is suppressed in transmitting the rotational power as compared to the case where the rotational power is transmitted only by contact.

### Other Embodiments

The above embodiment is not limited to the examples described above. The above embodiment may be modified as follows. For the variants described below, components substantially the same as those in the above embodiment are denoted by the same reference signs as those in the above embodiment.
In the above embodiment, the sectional structure of the rotary shaft 13 is not limited to the example described above. The section of the rotary shaft 13 perpendicular to the rotational center axis CX may have any shape that the rotational power can be applied to the transmission member 31 by rotation of the rotary shaft 13. More specifically, the section of the rotary shaft 13 has a non-circular shape, such as a polygon, a shape with a projection, and a shape with a groove.
In the above embodiment, the rotational center axis of the transmission member 31 is parallel with the rotational center axis CX of the rotary shaft 13, but it may not be aligned with the rotational center axis CX. In the case where the rotational center of the transmission member 31 is not aligned with that of the rotary shaft 13, the transmission member 31 is supported by a shaft member extending in parallel with the rotary shaft 13. This shat member is provided on the retainer 33. The rotary shat 13 is provided with a gear, and the transmission member 31 is provided with a gear that meshes with the gear of the rotary shaft 13. In this arrangement, the external teeth of the rotary shaft 13 mesh with the external teeth of the transmission member 31, and therefore, the rotary shaft 13 and the transmission member 31 rotate in opposite directions. The operation of the door driving device 10 is substantially the same as that described for the embodiment.
In the above embodiment, the base member 11 is formed as a rack in a rack-and-pinion structure, but it may be formed as, for example, a rail for guiding a roller. In this arrangement, the rotary moving unit 32 is formed as a roller contacting with the rail. The roller as the rotary moving unit 32 contacts with the rail as the base member 11, rotates by friction, and moves along the base member 11.
In the above embodiment, the rotational power of the rotary shaft 13 is transmitted to the rotary moving unit 32 through meshing between the first bevel gear 51 and the second bevel gear 56, but the structure for transmitting the rotational power is not limited to the bevel gears. For example, a face gear or a worm gear may be used to transmit the rotational power.
In the above embodiment, the transmission member 31 is not limited to the examples described above. For example, the transmission member 31 may be formed as, instead of the first bevel gear 51, a first roller having a truncated conical shape with a surface oblique to the rotational center axis CX. The rotary moving unit 32 includes a second roller having a truncated conical shape and configured to rotate by contact with the first roller having the truncated conical shape. The second roller of the rotary moving unit 32 is coaxial with the pinion gear 55. In this arrangement, the rotational power of the rotary shaft 13 is transmitted to the second roller of the rotary moving unit 32 via the first roller of the transmission member 31, and the pinion gear 55 rotates with the second roller of the rotary moving unit 32, resulting in movement of the moving unit 30.
In the above embodiment, the door driving device 10 moves the door leaf 3 of the railroad vehicle, but the object to be moved is not limited thereto. For example, the door driving device 10 is applicable to movement of a door leaf of a bus or a door leaf of a store.

What is claimed is:

1. A door driving device, comprising:
a base member extending in an opening width direction of a door;
a rotary moving unit pressed against the base member and configured to move along the base member while rotating;
a rotary shaft extending in the opening width direction of the door and configured to rotate by a power of a motor; and
a transmission member capable of moving relatively to the rotary shaft in an axial direction thereof and configured to rotate along with the rotary shaft and contact with the rotary moving unit, so as to transmit a rotational power of the rotary shaft to the rotary moving unit.

2. A door driving device, comprising:
a base member extending in an opening width direction of a door;
two rotary moving units pressed against the base member and configured to move along the base member while rotating;
a rotary shaft extending in the opening width direction of the door and configured to rotate by a power of a motor; and
two transmission members provided in association with the two rotary moving units, respectively, the two transmission members being capable of moving relatively to the rotary shaft in an axial direction thereof and configured to rotate along with the rotary shaft and contact with the two rotary moving units, so as to transmit a rotational power of the rotary shaft to the two rotary moving units,
wherein the two transmission members transmit the rotational power to the two rotary moving units such that the two rotary moving units rotate in opposite directions.

3. The door driving device of claim 2, wherein the motor is positioned in a middle portion in the opening width direction of the door.

4. The door driving device of claim 1, further comprising a retainer for retaining the rotary moving unit rotatably and retaining a door leaf.

5. The door driving device of claim 4, wherein the retainer includes a body portion, a first supported portion, and a second supported portion, the body portion retaining the rotary moving unit, the first supported portion being provided on the body portion and supported by the base member, the second supported portion being provided on the body portion and supported by the rotary shaft.

6. The door driving device of claim 4, wherein
the transmission member includes a first gear configured to rotate about a rotational center axis of the rotary shaft, and
wherein the rotary moving unit includes a second gear configured to mesh with the first gear.

7. The door driving device of claim 2, further comprising a retainer for retaining the rotary moving unit rotatably and retaining a door leaf.

8. The door driving device of claim 7, wherein the retainer includes a body portion, a first supported portion, and a second supported portion, the body portion retaining the rotary moving unit, the first supported portion being provided on the body portion and supported by the base member, the second supported portion being provided on the body portion and supported by the rotary shaft.

9. The door driving device of claim 7, wherein
the transmission member includes a first gear configured to rotate about a rotational center axis of the rotary shaft, and
wherein the rotary moving unit includes a second gear configured to mesh with the first gear.
